(19) United States
(12) Patent Application Publication
(10) Pub. No.: US 2007/0201016 A1
(43) Pub. Date: Aug. 30, 2007

(54) Method And Apparatus For Seasoning Semiconductor Apparatus Of Sensing Plasma Equipment

(75) Inventors: Yeong Su Song, Icheon-si (KR); Sang Ryong Oh, Suwon-si (KR); Sheung Ki Kim, Seongnam-si (KR); Nam Heon Kim, Suwon-si (KR)

Correspondence Address: CHRISTIE, PARKER & HALE, LLP, PO BOX 7068, PASADENA, CA, 91109-7068, US

(73) Assignee: ADAPTIVE PLASMA TECHNOLOGY CORP., GYEONGGI-DO (KR)

(21) Appl. No.: 10/584,108

(22) PCT Filed: Dec. 21, 2004
(86) PCT No.: PCT/KR04/03386

§ 371 Date: Apr. 11, 2007

(30) Foreign Application Priority Data
Dec. 22, 2003 (KR) 10-2003-0094414

(51) Int. Cl. G01N 21/00

(52) U.S. Cl. 356/72

(57) ABSTRACT

A plasma equipment seasoning method. The seasoning method comprising the steps of measuring the ratio of optical emission intensity of silicon oxide (SiOₓ)-based chemical species to optical emission intensity of carbon fluoride compound (CF_{y})-based chemical species present in a process chamber of plasma equipment before operating the plasma equipment to perform a plasma process, determining whether the value of the measured optical emission intensity ratio is within a predetermined range of normal state or not, and, when reaction gas to be used in the plasma process is supplied into the process chamber based on the result of determination such that the value of the measured optical emission intensity ratio is within the predetermined range of normal state, seasoning the interior of the process chamber to change the ratio of components of the reaction gas, and thus, to change the optical emission intensity ratio.

### TECHNICAL FIELD

The present invention relates to plasma equipment used in manufacturing semiconductor devices, and, more particularly, to a plasma equipment seasoning method and plasma equipment to which the plasma equipment seasoning method is applied.

### BACKGROUND ART

Recently, plasma equipment has been increasingly used in a semiconductor device manufacturing process. The plasma equipment is mainly used to deposit a material layer on a semiconductor wafer or etch the semiconductor wafer.

However, the following problem may be raised when the plasma equipment is operated to perform a semiconductor manufacturing process, such as a deposition process or an etching process. When the deposition or etching process is performed in a process chamber of the plasma equipment after a predetermined period of chamber idle time, initial defectiveness, which is called first wafer effect, may be generated. Especially when the etching process is performed, the first wafer effect is serious.

Such first wafer effect is generated when the etching rate is higher or lower than the normal state. For this reason, it is required that a method of eliminating the first wafer effect, for example, a seasoning method, be changed accordingly. Nevertheless, concrete regulation or standardization of such seasoning method has not yet been reported. Consequently, wafers having suffered the first wafer effect are discarded during actual mass production, and therefore, productivity is lowered.

Especially, the chamber idle time is inevitably provided during continuous production, and therefore, defective products may be produced during continuous production in addition to initial defectiveness of products in the chamber of the plasma equipment. Consequently, it is preferable to continuously diagnose the state of the chamber such that the initial defectiveness, such as first wafer effect, is prevented when a small number or a large number of products are manufactured.

### DISCLOSURE OF THE INVENTION

Therefore, the present invention has been made in view of the above problems, and it is an object of the present invention to provide a plasma equipment seasoning method that is capable of preventing initial defectiveness when plasma equipment is initially operated or when the plasma equipment is operated again after a predetermined period of chamber idle time, and plasma equipment to which the plasma equipment seasoning method is applied.

In accordance with one aspect of the present invention, the above and other objects can be accomplished by the provision of a plasma equipment seasoning method comprising the steps of: measuring the ratio of optical emission intensity of silicon oxide (SiOₓ)-based chemical species to optical emission intensity of carbon fluoride compound (CF_{y})-based chemical species present in a process chamber of plasma equipment before operating the plasma equipment to perform a plasma process; determining whether the value of the measured optical emission intensity ratio is within a predetermined range of normal state or not; and, when reaction gas to be used in the plasma process is supplied into the process chamber based on the result of determination such that the value of the measured optical emission intensity ratio is within the predetermined range of normal state, seasoning the interior of the process chamber to change the ratio of components of the reaction gas, and thus, to change the optical emission intensity ratio.

Preferably, the optical emission intensity ratio measuring step comprises: supplying the reaction gas to be used in the plasma process into the process chamber, exciting the reaction gas into a plasma, and performing spectroscopic analysis through optical emission measurement.

Preferably, the seasoning step comprises: if the value of the measured optical emission intensity ratio is above the upper limit value of the predetermined range of normal state, performing first seasoning to supply first reaction gas having relatively increased percentage of a component that increases the optical emission intensity of the carbon fluoride compound (CF_{y})-based chemical species among components of the reaction gas into the process chamber; and if the value of the measured optical emission intensity ratio is below the lower limit value of the predetermined range of normal state, performing second seasoning to supply second reaction gas having relatively increased percentage of a component that increases the optical emission intensity of the silicon oxide (SiOₓ)-based chemical species among components of the reaction gas into the process chamber.

Preferably, the reaction gas to be used in the plasma process includes carbon tetrafluoride (CF₄) and oxygen gas (O₂), the component that increases the optical emission intensity of the carbon fluoride compound (CF_{y})-based chemical species at the first seasoning step is the carbon tetrafluoride (CF₄), and the component that increases the optical emission intensity of the silicon oxide (SiOₓ)-based chemical species at the second seasoning step is the oxygen gas (O₂).

In accordance with another aspect of the present invention, there is provided plasma equipment comprising: a process chamber having an inner space defined therein for performing a plasma process; a plasma generating coil disposed on the process chamber for generating plasma; an optical emission spectroscopic analysis unit mounted to the wall of the process chamber for spectroscopically analyzing chemical species present in the process chamber; an optical emission intensity ratio value calculation unit for calculating the ratio of optical emission intensity of silicon oxide (SiOₓ)-based chemical species to optical emission intensity of carbon fluoride compound (CF_{y})-based chemical species from the results collected and spectroscopically analyzed by the optical emission spectroscopic analysis unit and comparing the value of the calculated optical emission intensity ratio with a predetermined range of normal state to determine whether seasoning is necessary and what kind of seasoning is appropriate if the seasoning is necessary; and a main control unit for controlling supply of reaction gas introduced into the process chamber to perform the seasoning based on the determination of the optical emission intensity ratio value calculation unit.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flow chart schematically illustrating a plasma equipment seasoning method according to a preferred embodiment of the present invention;

FIG. 2 is a sectional view showing an example of a plasma etching target to which the plasma equipment seasoning method according to the preferred embodiment of the present invention is applied;

FIGS. 3 to 5 are graphs schematically illustrating seasoning selection of the plasma equipment seasoning method according to the preferred embodiment of the present invention, respectively; and

FIG. 6 is a view schematically showing plasma equipment to which the plasma equipment seasoning method according to the preferred embodiment of the present invention is applied.

### BEST MODE FOR CARRYING OUT THE INVENTION

When plasma equipment that performs a plasma process for manufacturing semiconductor devices, such as a deposition process or an etching process, is operated again after a predetermined period of chamber idle time, reaction gas is supplied into a process chamber before a wafer is introduced into the process chamber such that plasma is generated, and then the state of the interior of the process chamber is diagnosed such that initial defectiveness, such as first wafer effect, is prevented. This method is proposed by a preferred embodiment of the present invention, which will be described below in detail.

In order to effectively diagnose the state of the interior of the process chamber, the preferred embodiment of the present invention proposes use of the ratio of emission intensity of silicon oxide (SiOₓ) to emission intensity of carbon fluoride compound (CF_{y}), which are obtained from the results of spectroscopic analysis on the state of plasma in the chamber, as measurement parameters for diagnosis. In the preferred embodiment of the present invention, the ratio of emission intensity (i.e., emission intensity of silicon oxide (SiOₓ)/emission intensity of carbon fluoride compound (CF_{y})) is set as measurement parameter K.

Also, a determination is made as to whether the value of the measurement parameter K is within a predetermined range of normal state, for example, between an upper limit value KU and a lower limit value KL according to the preferred embodiment of the present invention. If it is determined that the value of the measurement parameter is within the predetermined range of normal state, a wafer is introduced into the chamber to perform a predetermined process. If it is determined that the value of the measurement parameter is not within the predetermined range of normal state, on the other hand, the state of the interior of the chamber is seasoned. Generally, two types of seasoning are performed. Specifically, first seasoning is performed when the value of the measurement parameter K is above the upper limit value KU, and second seasoning is performed when the value of the measurement parameter K is below the lower limit value KL. After it is confirmed that the value of the measurement parameter K is within the predetermined range of normal state through such seasoning, the wafer is introduced into the chamber, and then an actual plasma process is performed.

Also, the present invention provides plasma equipment constructed such that the measurement parameter K is effectively measured during operation of the plasma equipment, and required seasoning is performed depending upon the respective situations. Such plasma equipment is useful to continuously diagnose the state of the chamber such that a small number or a large number of products are prevented from being defective.

Initial defectiveness, such as first wafer effect, generated when the plasma equipment is operated again after a predetermined period of chamber idle time is substantially further serious and fatal in an etching process using plasma, which will be described below in detail for example. The preferred embodiment of the present invention is applied to the case that initial defectiveness is generated when the plasma equipment is operated again after a predetermined period of chamber idle time while the plasma equipment is normally operated, although the preferred embodiment of the present invention may be effectively used to continuously inspect and diagnose the state of the chamber while the plasma equipment is operated or to inspect and diagnose the state of the chamber when the plasma equipment is initially operated.

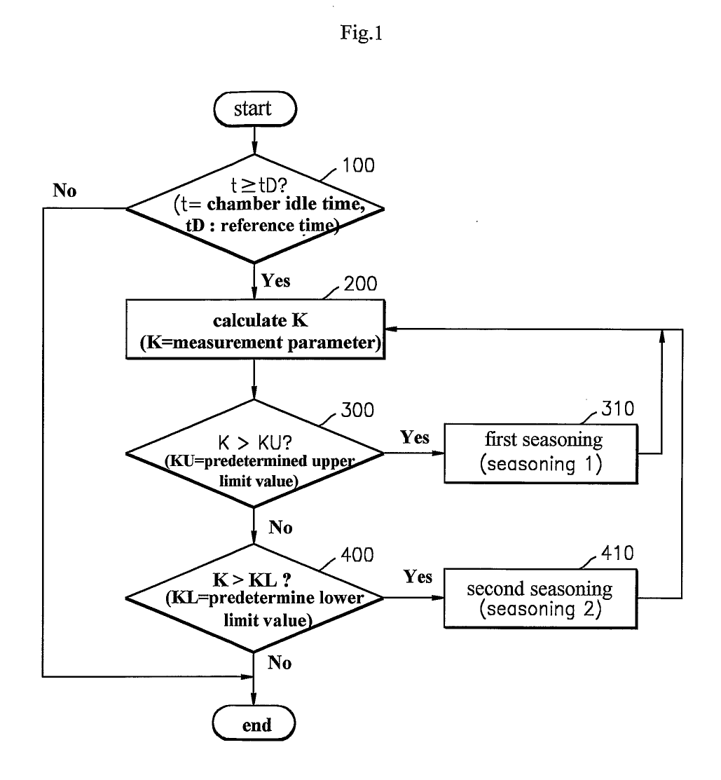

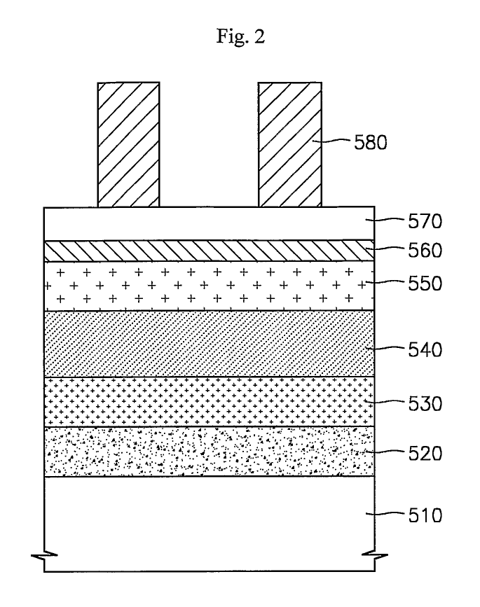

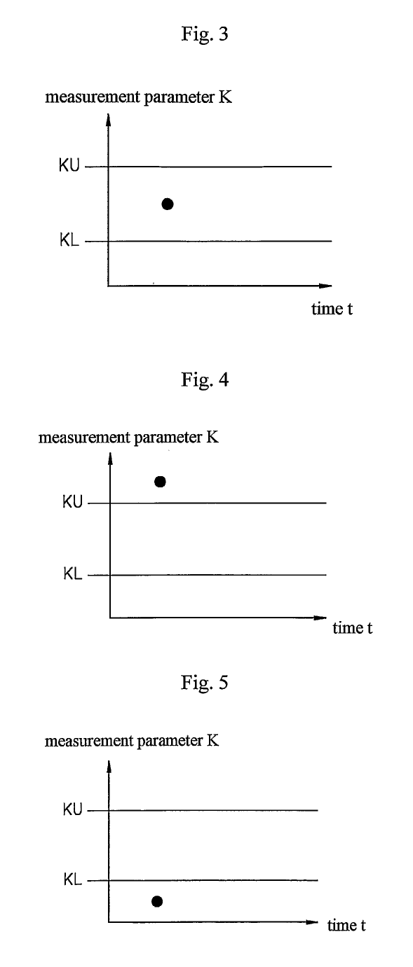

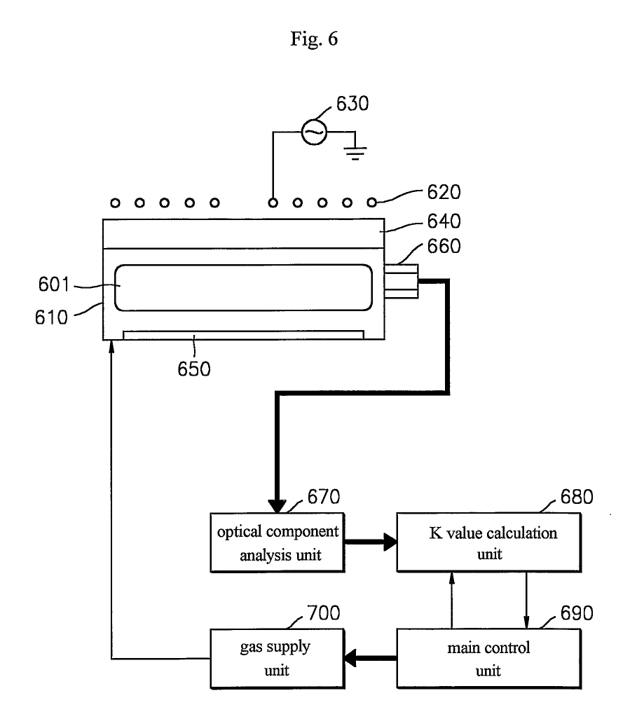

FIG. 1 is a flow chart schematically illustrating a plasma equipment seasoning method according to a preferred embodiment of the present invention, FIG. 2 is a sectional view showing an example of a plasma etching target to which the plasma equipment seasoning method according to the preferred embodiment of the present invention is applied, FIGS. 3 to 5 are graphs schematically illustrating seasoning selection of the plasma equipment seasoning method according to the preferred embodiment of the present invention, respectively, and FIG. 6 is a view schematically showing plasma equipment to which the plasma equipment seasoning method according to the preferred embodiment of the present invention is applied.

Referring to FIG. 1, the plasma equipment seasoning method according to the preferred embodiment of the present invention is substantially useful in the case that the plasma equipment is operated again after a predetermined period of chamber idle time while the plasma equipment is normally operated, although the plasma equipment seasoning method according to the preferred embodiment of the present invention is also useful to inspect and diagnose the state of the interior of the chamber while the plasma equipment is operated or when the plasma equipment is initially operated. For clarity of description, however, a detailed description will be given hereinafter of the case that a plasma process, for example, an etching process using plasma is performed in the plasma equipment after a predetermined period of chamber idle time.

The chamber idle time means time necessary to maintain the plasma equipment in the state that reaction gas is not supplied into the chamber and radio frequency (RF) power is not applied to excite the reaction gas into a plasma while vacuum is maintained in the chamber, in which the actual plasma process is performed. Also, the plasma process may be a deposition process or an etching process. For clarity of description, an etching process using plasma, which generates serious defectiveness, such as first wafer effect, when the plasma equipment is operated again after a predetermined period of chamber idle time, will be described below in detail for example.

As shown in FIG. 1, the method of seasoning the interior of the chamber of the plasma equipment begins with determination as to whether chamber idle time t, i.e., time for which the chamber is not operated, is greater than predetermined reference time tD (Step 100).

The chamber idle time t is time for which the plasma process is not performed on the wafer in the chamber of the plasma equipment, which is easily measured. The reference time tD is experimentally measured. Specifically, the reference time means the maximum time for which initial defectiveness, such as first wafer effect, is not generated. Consequently, the reference time tD may be changed according to plasma processes or plasma equipment, and therefore, the reference time tD is experimentally set for the respective plasma processes or the respective plasma equipment.

If the chamber idle time t is below the reference time tD as a result of comparison between the chamber idle time t and the reference time tD, the process of seasoning the chamber of the plasma equipment may be omitted, which is very advantageous in terms of productivity. If the chamber idle time t is not less than the reference time tD as a result of comparison between the chamber idle time t and the reference time tD, the seasoning process according to the preferred embodiment of the present invention is performed.

When the chamber idle time t is not less than the reference time tD as a result of comparison between the chamber idle time t and the reference time tD, and thus, the chamber seasoning is required, the value of the measurement parameter K on the current state in the chamber of the plasma equipment is measured (Step 200).

The value of the measurement parameter K is obtained to inspect or diagnose the current state of the interior of the chamber. Consequently, the current state of the interior of the chamber of the plasma equipment is measured, and the value of the measurement parameter K is obtained from the measurement result. The value of the measurement parameter K is measured through component analysis of chemical species in the chamber, which seriously affects the plasma process.

For example, when the plasma process performed in the plasma equipment is an etching process for patterning a material layer, a carbon fluoride compound (CF_{y}) and silicon oxide (SiOₓ) are selected as chemical species seriously affecting the etching process, which may be principal components directly participating in etching reaction or constituting by-products obtained by the etching reaction in a typical semiconductor device manufacturing process.

For example, when the plasma process is an etching process for patterning a plasma etching target comprising: a lower material layer 510 formed on a wafer, the lower material layer 510 being a silicon oxide layer; a titanium/titanium nitride (Ti/TiN) layer 520 having a thickness of approximately 60 Å/200 Å formed on the lower material layer; a titanium nitride layer 530 formed on the titanium/titanium nitride layer, the titanium nitride layer 530 being a barrier layer having a thickness of approximately 200 Å; a tungsten (W) layer 540 having a thickness of approximately 900 Å formed on the titanium nitride layer; a silicon nitride (SiN) layer 550 formed on the tungsten layer, the silicon nitride layer 550 being a hard mask having a thickness of approximately 2300 Å; a silicon oxynitride (SiON) layer 560 formed on the silicon nitride layer, the silicon oxide-nitride layer 560 being an anti-reflection layer (ARC) having a thickness of approximately 1000 Å; an organic bottom anti-reflection layer (OBARC) 570 having a thickness of approximately 600 Å formed on the silicon oxide-nitride layer; and a photoresist pattern 580 formed on the organic bottom anti-reflection layer, as shown in FIG. 2, a carbon fluoride compound (CF_{y}) and silicon oxide (SiOₓ) are selected as chemical species in the process chamber, which affect the etching process.

The reason why the carbon fluoride compound (CF_{y}) and the silicon oxide (SiOₓ) are selected is that components of chemical species analyzed in the chamber are various, and selection of such various components of chemical species is very difficult and ineffective, and furthermore, these various components of chemical species differently affect the plasma process. Consequently, the carbon fluoride compound (CF_{y}) and the silicon oxide (SiOₓ), which are principal components directly participating in the plasma process or constituting polymer adsorbed to the inner wall of the chamber as by-products, are selected to obtain the value of the measurement parameter K.

In the preferred embodiment of the present invention, the value of the measurement parameter K is set as the ratio of emission intensity of silicon oxide (SiOₓ) to emission intensity of carbon fluoride compound (CF_{y}), i.e., emission intensity of silicon oxide (SiOₓ)/emission intensity of carbon fluoride compound (CF_{y}), which are obtained from the results of spectroscopic analysis of the state of plasma in the chamber. This setting of the value of the measurement parameter K is very appropriate for experimentally evaluating the state of the interior of the chamber, in which the plasma process is performed.

The results of spectroscopic analysis on the state of the interior of the chamber must be obtained in order to measure the value of the measurement parameter K. To this end, the plasma equipment is constructed to analyze components of chemical species present in the chamber, which is shown in FIG. 6. Accordingly, the construction for analyzing the components of chemical species present in the chamber in real time will be described first.

Referring to FIG. 6, the plasma equipment used in the preferred embodiment of the present invention generally comprises a process chamber 610 having an inner space isolated from the outside such that a wafer is subjected to the plasma process, for example, a plasma etching process, in the inner space of the process chamber 610. At the lower part in the inner space of the process chamber 610 is disposed a wafer supporting part 650, on which the wafer is mounted. Although not shown, a bias power part is electrically connected to the wafer supporting part 650 for applying bias power to the wafer. The wafer supporting part 650 may be an electrostatic chuck (ESC), which is commonly used in semiconductor manufacturing equipment.

On the process chamber 610 is disposed a dome 640 for hermetically sealing the process chamber 610. On the dome 640 is disposed a plasma generating coil 620 for providing electromagnetic field necessary to generate plasma. The plasma generating coil 620 may be manufactured in various shapes. A source power part 630 is electrically connected to the plasma generating coil 620 for applying radio frequency (RF) power to plasma generating coil 620 as source power.

On the wall of the process chamber 610 is mounted a view port 660 for allowing chemical species present in the inner space of the process chamber 610 to be analyzed with an optical analysis tool. The view port 660 is used as a passage for collecting light generated in the process chamber 610. Optical information collected by the view port 660 is transmitted to an optical component analysis unit 670, which is connected to the view port 660. The optical component analysis unit 670 analyzes the light generated in the process chamber 610 to identify components of chemical species present in the processing chamber 610.

The optical component analysis unit 670 may be an optical emission spectroscopy (OES). The optical emission spectroscopy (OES) is used to measure by-products newly generated from chemical reaction or to measure reflection intensity of irradiated external light source. In the preferred embodiment of the present invention, the optical emission spectroscopy serves to analyze by-products or components of chemical species present in the process chamber 610. The optical emission spectroscopy (OES) comprises a multi-channeled charge coupled device (CCD) and an analyzing part for analyzing optical signal information obtained from the multi-channeled charge coupled device. Consequently, the optical emission spectroscopy is advantageous in performing real-time spectroscopic analysis.

In the preferred embodiment of the present invention, the optical component analysis unit 670 constituting such optical emission spectroscopy (OES) is used not only to provide results of component analysis, which is necessary to obtain the value of the measurement parameter K but also to detect an end point when the plasma process is performed on the wafer (end point detection (EPD) function).

The results of component analysis obtained from the optical component analysis unit 670 constituting the optical emission spectroscopy (OES) is expressed in terms of emission intensity for chemical species. The results are transmitted to a K value calculation unit 680. The K value calculation unit 680 samples data regarding emission intensity of silicon oxide (SiOₓ) and emission intensity of carbon fluoride compound (CF_{y}) to calculate the value of the measurement parameter K.

The K value calculation unit 680 compares the calculated K value with the predetermined upper limit value KU and the predetermined lower limit value KL, and transmits the results of comparison to a main control unit 690, which will be described below in detail. The main control unit 690 selects appropriate seasoning process based on the results of comparison, and then controls a gas supply unit 700 such that reaction gas is supplied into the chamber 610 according to the selected seasoning process. The gas supply unit comprises a control valve for controlling a reaction gas source and flow of the supplied reaction gas, for example, a mass flow controller (MFC).

While reaction gas required to perform the plasma process in the chamber of the plasma equipment is supplied, and source power is applied to the plasma generating coil 620 to generate plasma 601, spectroscopic analysis is performed to measure the value of the measurement parameter K. In this case, chemical species in plasma excited by the reaction gas and chemical species generated through reaction between the plasma and by-products of the previous plasma process, such as polymer adsorbed to the inner wall of the chamber 610 influence the results of spectroscopic analysis. In the actual plasma process, reaction between the plasma and the polymer is involved. Consequently, it is necessary that the results of spectroscopic analysis be collected under the conditions maximally similar to the actual plasma process. At this time, the wafer may not be introduced into the chamber 610 to prevent unnecessary consumption of the wafer.

Referring back to FIG. 1, the value of the measured and calculated measurement parameter K is compared with the predetermined upper limit value KU and the predetermined lower limit value KL to determine whether seasoning is necessary and what kind of seasoning is appropriate if the seasoning is necessary (Step 300 and Step 400).

Specifically, the value of the measurement parameter K is compared with the predetermined upper limit value KU and the predetermined lower limit value KL. The predetermined upper limit value KU and the predetermined lower limit value KL are experimentally set. For example, the range of the K value within which initial defectiveness, such as first wafer effect, is not generated when the plasma process is performed is experimentally measured. The upper limit value of the measured K value is set as the upper limit value KU, and the lower limit value of the measured K value is set as the lower limit value KL. The range of the K value within which such initial defectiveness is not generated means the range of the K value that can be measured when the plasma process is normally performed.

Consequently, if it is determined that the previously measured K value is within the range of the K value in normal state as shown in FIG. 3, it is not necessary to perform any seasoning process. If the measured K value is not within the range of the K value in normal state as shown in FIGS. 4 and 5, it is necessary to perform an appropriate seasoning process such that the K value is within the range of the K value in normal state.

Specifically, when the measured K value is above the predetermined upper limit value KU, i.e., the measured K value is above the upper limit of the range of the K value in normal state as shown in FIG. 4, first seasoning is performed such that the K value is within the range of the K value in normal state (Step 310). That the measured K value is above the predetermined upper limit value KU means that more than the required percentage of silicon oxide (SiOₓ) is present in the process chamber 610 (see FIG. 6). Consequently, the first seasoning (Step 310) is performed to decrease the percentage of the silicon oxide (SiOₓ), i.e., to increase the percentage of carbon fluoride compound (CF_{y}), which is the other factor deciding the K value.

The first seasoning (Step 310) is performed to further supply reaction gas including a component that can provide such carbon fluoride compound (CF_{y}) into the process chamber 610 (see FIG. 6) such that emission intensity of the carbon fluoride compound (CF_{y}) is increased according to the results of spectroscopic analysis. For example, when the reaction gas used in the plasma process, such as etching gas, includes carbon fluoride-based gas (CF_{y}), such as carbon tetrafluoride (CF₄), and oxygen gas (O₂), the first seasoning process (Step 310) is performed to increase the percentage of the carbon tetrafluoride (CF₄) such that the ratio in percentage of the carbon tetrafluoride (CF₄) to the oxygen gas (O₂) of the etching gas supplied into the process chamber 610 is higher than that of the etching gas in normal state.

After the first seasoning (Step 310) is performed as described above, the value of the measurement parameter K is measured and calculated through spectroscopic analysis to determine whether the value of the measurement parameter K is within the range of the K value in normal state. If the measured K value is still above the predetermined upper limit value KU, the first seasoning process (Step 310) is repeated until the measured K value is within the range of the K value in normal state as shown in FIG. 1. If the measured K value is below the predetermined upper limit value KU, on the other hand, the following step is performed.

If the K value measured after performing the first seasoning (Step 310) or the initially measured K value is below the predetermined upper limit value KU, the measured K value is compared with the predetermined lower limit value KL (Step 400). If the measured K value is below the predetermined lower limit value KL, i.e., the measured K value is below the lower limit of the range of the K value in normal state as shown in FIG. 5, second seasoning is performed such that the K value is within the range of the K value in normal state (Step 410). That the measured K value is below the predetermined lower limit value KL means that more than the required percentage of carbon fluoride compound (CF_{y}) is present in the process chamber 610 (see FIG. 6). Consequently, the second seasoning (Step 410) is performed to decrease the percentage of the carbon fluoride compound (CF_{y}), i.e., to increase the percentage of silicon oxide (SiOₓ), which is the other factor deciding the K value.

The second seasoning (Step 410) is performed to further supply reaction gas including a component that can increase the emission intensity of the silicon oxide (SiOₓ) into the process chamber 610 (see FIG. 6) such that emission intensity of the silicon oxide (SiOₓ) is increased according to the results of spectroscopic analysis. For example, when the reaction gas used in the plasma process, such as etching gas, includes carbon fluoride-based gas (CF_{y}), such as carbon tetrafluoride (CF₄), and oxygen gas (O₂), the second seasoning process (Step 410) is performed to decrease the percentage of the carbon tetrafluoride (CF₄) such that the ratio in percentage of the carbon tetrafluoride (CF₄) to the oxygen gas (O₂) of the etching gas supplied into the process chamber 610 is lower than that of the etching gas in normal state.

After the second seasoning (Step 410) is performed as described above, the value of the measurement parameter K is measured and calculated through spectroscopic analysis to determine whether the value of the measurement parameter K is within the range of the K value in normal state. If the measured K value is still below the predetermined lower limit value KL, the second seasoning process (Step 410) is repeated until the measured K value is within the range of the K value in normal state as shown in FIG. 1. At this time, if the previously measured K value is above the predetermined upper limit value KU, the first seasoning process (Step 310) is repeated.

When the measured K value is between the predetermined upper limit value KU and the predetermined lower limit value KL, the seasoning process is completed.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

According to the present invention, initial defectiveness, such as first wafer effect, is effectively prevented through minimal modification of the existing plasma equipment, and therefore, the manufacturing costs of semiconductor devices are reduced. Furthermore, a determination can be made as to whether seasoning is necessary or not before the plasma equipment is operated again after a predetermined period of idle time of the plasma equipment, and appropriate seasoning can be performed based on the determination. The structure of the system for determining whether the seasoning is necessary and performing the seasoning is simple, and therefore, the seasoning system can be easily mounted to the plasma equipment.

### INDUSTRIAL APPLICABILITY

The present invention is applied to the semiconductor manufacturing equipment field in which semiconductor devices are manufactured using plasma equipment and the semiconductor manufacturing field in which the semiconductor manufacturing equipment is used.

1. A plasma equipment seasoning method comprising the steps of:
measuring the ratio of optical emission intensity of silicon oxide (SiOₓ)-based chemical species to optical emission intensity of carbon fluoride compound (CF_{y})-based chemical species present in a process chamber of plasma equipment before operating the plasma equipment to perform a plasma process;
determining whether the value of the measured optical emission intensity ratio is within a predetermined range of normal state or not; and
when reaction gas to be used in the plasma process is supplied into the process chamber based on the result of determination such that the value of the measured optical emission intensity ratio is within the predetermined range of normal state, seasoning the interior of the process chamber to change the ratio of components of the reaction gas, and thus, to change the optical emission intensity ratio.

2. The method as set forth in claim 1, wherein the optical emission intensity ratio measuring step comprises:
supplying the reaction gas to be used in the plasma process into the process chamber, changing the reaction gas into a plasma state, and performing spectroscopic analysis through optical emission measurement.

3. The method as set forth in claim 1, wherein the seasoning step comprises:
if the value of the measured optical emission intensity ratio is above the upper limit value of the predetermined range of normal state,
performing first seasoning to supply first reaction gas having relatively increased percentage of a component that increases the optical emission intensity of the carbon fluoride compound (CF_{y})-based chemical species, among components of the reaction gas, into the process chamber; and
if the value of the measured optical emission intensity ratio is below the lower limit value of the predetermined range of normal state,
performing second seasoning to supply second reaction gas having relatively increased percentage of a component that increases the optical emission intensity of the silicon oxide (SiOₓ)-based chemical species, among components of the reaction gas, into the process chamber.

4. The method as set forth in claim 3, wherein
the reaction gas to be used in the plasma process includes carbon tetrafluoride (CF₄) and oxygen gas (O₂),
the component that increases the optical emission intensity of the carbon fluoride compound (CF_{y})-based chemical species at the first seasoning step is the carbon tetrafluoride (CF₄), and
the component that increases the optical emission intensity of the silicon oxide (SiOₓ)-based chemical species at the second seasoning step is the oxygen gas (O₂).

5. Plasma equipment comprising:
a process chamber having an inner space defined therein for performing a plasma process;
a plasma generating coil disposed on the process chamber for generating plasma;
an optical emission spectroscopic analysis unit mounted to the wall of the process chamber for spectroscopically analyzing chemical species present in the process chamber;
an optical emission intensity ratio value calculation unit for calculating the ratio of optical emission intensity of silicon oxide (SiOₓ)-based chemical species to optical emission intensity of carbon fluoride compound (CF_{y})-based chemical species from the results collected and spectroscopically analyzed by the optical emission spectroscopic analysis unit and comparing the value of the calculated optical emission intensity ratio with a predetermined range of normal state to determine whether seasoning is necessary and what kind of seasoning is appropriate if the seasoning is necessary; and
a main control unit for controlling supply of reaction gas introduced into the process chamber to perform the seasoning based on the determination of the optical emission intensity ratio value calculation unit.
